(19) United States
(12) Patent Application Publication
(10) Pub. No.: US 2018/0196452 A1
(43) Pub. Date: Jul. 12, 2018

(54) Digital Calibration Method for a Low Power Reference Generator

(71) Applicant: Ambiq Micro, Inc., Austin, TX (US)

(72) Inventors: Joseph HAMILTON, Austin, TX (US); Yanning LU, Austin, TX (US); Ivan BOGUE, Austin, TX (US)

(73) Assignee: Ambiq Micro, Inc., Austin, TX (US)

(21) Appl. No.: 15/405,241

(22) Filed: Jan. 12, 2017

(51) Int. Cl. G05F 1/46

(52) U.S. Cl. CPC G05F 1/468; G05F 1/461

(57) ABSTRACT

A method for digitally calibrating, selectively during normal operation, a low-power reference signal generator adapted to develop an analog reference signal as a function of a digital control signal. In the feed-back loop, an ADC, referenced to a band-gap reference, is adapted to facilitate compensation for drift and other low-frequency errors that may develop in the field. This method can be applied to both voltage and current reference signal generators.

### BACKGROUND OF THE INVENTION

### 1. Field of the Invention

The present invention relates to a digital calibration method for a low power voltage reference generator.

### 2. Description of the Related Art

In general, in the descriptions that follow, the first occurrence of each special term of art that should be familiar to those skilled in the art of integrated circuits (“ICs”) and systems will be italicized. In addition, when a term that may be new or that may be used in a context that may be new, that term will be set forth in bold and at least one appropriate definition for that term will be provided. In addition, throughout this description, the terms assert and negate may be used when referring to the rendering of a signal, signal flag, status bit, or similar apparatus into its logically true or logically false state, respectively, and the term toggle to indicate the logical inversion of a signal from one logical state to the other. Alternatively, the mutually exclusive boolean states may be referred to as logic_0 and logic_1. Of course, as is well known, consistent system operation can be obtained by reversing the logic sense of all such signals, such that signals described herein as logically true become logically false and vice versa. Furthermore, it is of no relevance in such systems which specific voltage levels are selected to represent each of the logic states.

Hereinafter, reference to a facility shall mean a circuit or an associated set of circuits adapted to perform a particular function regardless of the physical layout of an embodiment thereof. Thus, the electronic elements comprising a given facility may be instantiated in the form of a hard macro adapted to be placed as a physically contiguous module, or in the form of a soft macro the elements of which may be distributed in any appropriate way that meets speed path requirements. In general, electronic systems comprise many different types of facilities, each adapted to perform specific functions in accordance with the intended capabilities of each system. Depending on the intended system application, the several facilities comprising the hardware platform may be integrated onto a single integrated circuit (“IC”), or distributed across multiple ICs. Depending on cost and other known considerations, the electronic components, including the facility-instantiating IC(s), may be embodied in one or more single- or multi-chip packages. However, unless expressly stated to the contrary, the form of instantiation of any facility shall be considered as being purely a matter of design choice.

Non-volatile solid-state memory systems are widely used in a variety of mobile and handheld devices, notably smart phones, tablets, laptops, and other consumer electronics products. Solid state memory, which can include embedded or stand-alone charge-based flash memory, phase change memory, resistive RAM (“RRAM”), or magneto-resistive memory (“MRAM”), is of particular advantage for battery operated mobile devices that have limited available power. Typically, electronic systems in such devices have processors, microcontrollers (“MCUs”), or other electronic controllers that support architected power states (e.g., an active state, a stand-by or sleep state, a deep sleep state, etc.). As compared to active states, the power consumption in these electronic systems can be significantly reduced when the device is maintained in stand-by or sleep states.

Shown in FIG. 1 is a typical general purpose computer system 10. Although not all of the electronic components illustrated in FIG. 1 may be operable in the sub-threshold or near-threshold domains in any particular embodiment, some, at least, may be advantageously adapted to do so, with concomitant reductions in system power dissipation. In particular, in recently-developed battery-powered mobile systems, such as smart-phones and the like, many of the discrete components typical of desktop or laptop devices illustrated in FIG. 1 are integrated into a single integrated circuit (“IC”) chip.

Shown in FIG. 2 is a typical integrated system 12 comprising, inter alia, reference voltage (“V_{Ref}”) generator 14, reference current (“I_{Ref}”) generator 16, an analog-to-digital converter (“ADC”) 18, a digital-to-analog converter (“DAC”) 20 and a low-dropout (“LDO”) regulator 22. The voltage and current reference generators 14 and 16, respectively, are fundamental components of nearly all modern ICs. The voltages and currents they produce are often used by multiple blocks, and the tolerances of these voltages and currents may determine the overall performance of various facilities instantiated on the chip.

Nano-amp reference voltage generators are known which can achieve +/−20% of total variation over process, voltage, and temperature, while consuming only 1 nA of quiescent current. This variation can be reduced to approximately +/−5% by calibrating process and mismatch errors at production test. While +/−5% may be sufficient for some applications, it may still limit the design of downstream circuits by, inter alia:
Increasing the variation of an analog supply voltage which further constrains the design and leads to additional power consumption;
Increasing the variation of a digital supply voltage which may lead to difficulty at timing closure as well as additional power consumption;
Limiting achievable ADC and DAC gain and offset; and
Requiring a larger typical bias current in each block in order to guarantee a minimum bias current with variation.

In order to achieve +/−5% accuracy over supply and temperature, the inherent process and mismatch-induced errors in the reference need to be reduced. Modern implementations often use digital trimming for this purpose. FIG. 3 shows a functional model of a reference voltage generator capable of digital trimming during production test. The DAC provides digital control of internal circuitry to vary V_{REF} as a function of the input digital code, D_{IN}. For example, D_{IN} may be developed by iterations of V_{REF} measurements followed by D_{IN} adjustments. Once the calibration is deemed complete, D_{IN} is recorded, e.g., in the Flash memory or other suitable One-Time-Programmable (“OTP”) memory (not shown). An analogous method is known for reference current generators.

Although “At Test” trimming is effective in many ways, it is unable entirely to remove some sources of error that may still degrade the performance of a reference generator in the field, including:
Supply voltage sensitivity
Temperature
Drift
Aging
Noise

What is needed is a method and apparatus for trimming the reference voltage during operation in the field.

### BRIEF SUMMARY OF THE INVENTION

In accordance with a first embodiment, a method is provided for digitally calibrating, selectively during normal operation, a reference signal generator adapted to develop an analog reference signal as a function of a digital control signal. In this embodiment, the method first develops a digital reference signal as a function of the analog reference signal. A digital ideal reference signal is also developed. Finally, the digital control signal is developed as a function of a difference between the digital reference signal and the digital ideal reference signal.

In accordance with another embodiment, a reference signal generator facility is configured to perform the above method.

In accordance with one other embodiment, an electronic system comprises this reference signal generator facility.

In accordance with yet another embodiment, a non-transitory computer readable medium includes executable instructions which, when executed in a processing system, causes the processing system to perform the steps of the above method.

### BRIEF DESCRIPTION OF THE SEVERAL VIEWS OF THE DRAWINGS

The invention may be more fully understood by a description of certain preferred embodiments in conjunction with the attached drawings in which:

FIG. 1 illustrates, in block diagram form, a general purpose computer system adapted to practice my invention;

FIG. 2 illustrates, in block diagram form, a typical integrated system adapted to practice my invention;

FIG. 3 illustrates, in block diagram form, a prior art embodiment for reference voltage calibration during production test;

FIG. 4 illustrates, in block diagram form, one embodiment for reference voltage calibration during normal circuit operation;

FIG. 5 illustrates, in block diagram form, one embodiment for reference current calibration during normal circuit operation; and

FIG. 6 illustrates, in flow diagram form, a method for selectively calibrating, during normal circuit operation, a reference signal, which can be either voltage or current.

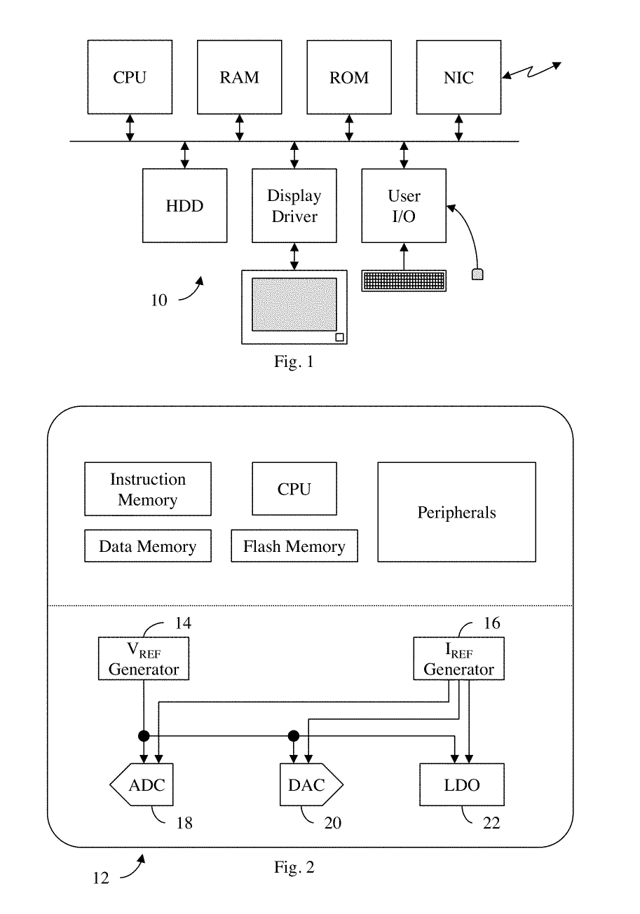

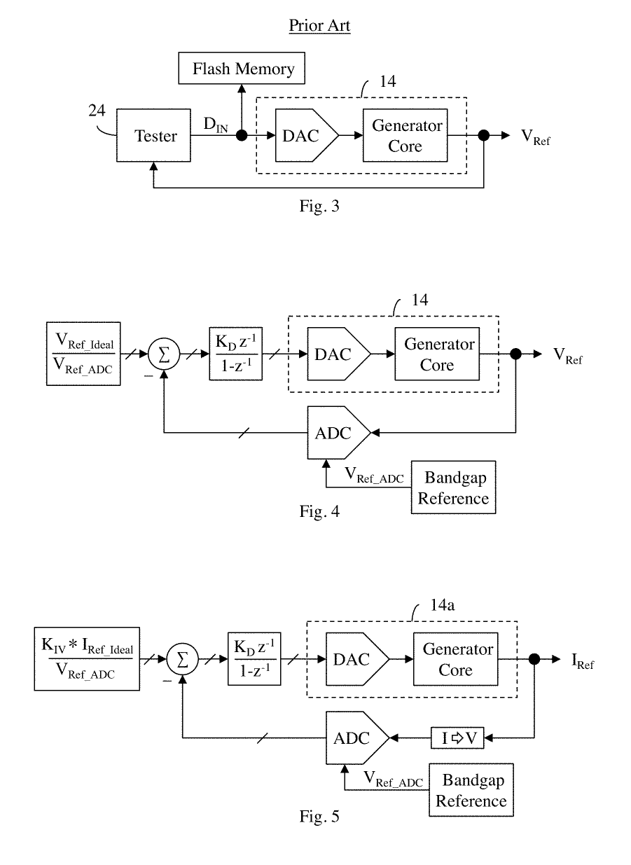

In the drawings, similar elements will be similarly numbered whenever possible. However, this practice is simply for convenience of reference and to avoid unnecessary proliferation of numbers, and is not intended to imply or suggest that the invention requires identity in either function or structure in the several embodiments.

### DETAILED DESCRIPTION OF THE INVENTION

In order to correct for the low-frequency components of the several errors noted above, the embodiment shown in FIG. 4 creates a feedback loop capable of measuring and adjusting V_{REF} on the fly. In this embodiment, an ADC has been added which is referenced to a reference voltage V_{REF}_{_}_{ADC}, and which is adapted to generate a digital code which represents the ratio of the present value of V_{REF} to V_{REF}_{_}_{ADC}. A comparator then compares this value to the ideal ratio of V_{REF} and V_{REF}_{_}_{ADC} which is stored numerically in digital format. A digital loop filter is provided to suppress random variations in the ADC output and to develop an averaged digital code to provide to the reference voltage generator 14. Care must be taken to account for loop delays through each block and to ensure stability, for example, the reference voltage generator 14, which likely has a low-bandwidth given its nano-amp current consumption.

Once the calibration cycle is complete, the ADC and bandgap reference can be powered down to save power. Since this calibration loop will typically be employed only to correct for very low frequency errors, a calibration cycle can be performed once a second or even less frequently. If the ADC and bandgap reference only need to be powered up for 1 μs, the duty-cycling of these blocks over a 1 second period means their contribution to the average power of the chip is only 1/1,000,000^{th} of their active power.

In another embodiment, shown in FIG. 5, the present invention can be extended to current calibration. With the addition of a current-to-voltage (“I-to-V”) converter, a reference current, I_{REF}, developed by a reference current generator 14a, can be converted to a respective reference voltage which can then be processed by the ADC. The loop then compares I_{REF} to the ratio of the ideal reference current value times the I-to-V gain, K_{IV}, over the ADC reference voltage.

A model of the embodiment show in FIG. 4 was built in Virtuoso with a transistor-level model of the reference voltage generator 14, and VerilogA models for all other blocks. Table 1, below, summarizes the parameter values that were used. Once the loop settled at approximately 8 seconds, the trim codes begin to toggle between two values in order to achieve an average value of exactly 580 mV. If undesired, this toggling can be prevented by opening the loop after lock is acquired.

TABLE 1
Reference Voltage Model Parameter Values

| Parameter | Value | |
|---|---|---|
| V_{REF, ideal} | 580 | mV |
| V_{REF, ADC} | 1.2 | V |
| ADC resolution | 12 | bits |
| K_{D} | 0.05 | |
| DAC gain | 6 | mV/bit |

Similarly, a model of FIG. 5 was built in Virtuoso with a transistor-level model of the reference current generator 14a, and VerilogA models for all other blocks. Table 2, below, summarizes the parameter values that were used.

TABLE 2
Reference Current Model Parameter Values

| Parameter | Value | |
|---|---|---|
| V_{REF, ideal} | 400 | pA |
| K_{IV} | 250 | MV/A |
| V_{REF, ADC} | 1.2 | V |
| ADC resolution | 12 | bits |
| K_{D} | 0.25 | |
| DAC gain | 1.5 | pA/bit |

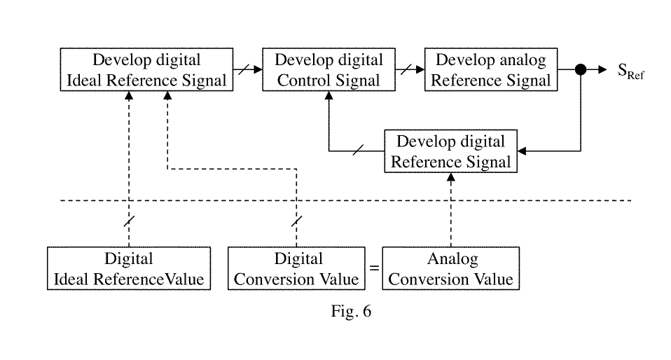

Shown in FIG. 6, is a general method for digitally calibrating, selectively during normal operation, a reference signal generator adapted to develop an analog reference signal, S_{Ref}, as a function of a digital control signal. Although, as can be seen, the method comprises a continuously-operating feed-back loop, it can be understood by starting with the development of a digital reference signal as a function of the analog reference signal. Substantially simultaneously, a digital ideal reference signal is developed. The digital control signal is thereafter developed as a function of a difference between the digital reference signal and the digital ideal reference signal. Optionally, the digital reference signal may be developed as a function of the analog reference signal and a selected conversion value; and, in this embodiment, the digital ideal reference signal may be developed as a function of a selected ideal reference value and a digital conversion value equivalent to the analog conversion value. This method can be effectively instantiated in embodiments adapted to operate in either a voltage reference mode, e.g., FIG. 4, or a current reference mode, e.g., FIG. 5. As will be understood by those skilled in this art, a non-transitory computer readable medium may be instantiated to include executable instructions which, when executed in a processing system, causes the processing system to perform the steps of this method.

It will be apparent to those skilled in the art that various modifications and variations can be made without departing from the spirit or scope of the invention. Thus, it is intended that the disclosed embodiments cover modifications and variations that come within the scope of the claims that eventually issue in a patent(s) originating from this application and their equivalents. In particular, it is explicitly contemplated that any part or whole of any two or more of the embodiments and their modifications described above can be combined in whole or in part.

1. A method for digitally calibrating, selectively during normal operation, a reference signal generator adapted to develop an analog reference signal as a function of a digital control signal, the method comprising the steps of:
[1.1] developing a digital reference signal as a function of the analog reference signal;
[1.2] developing a digital ideal reference signal; and
[1.3] developing the digital control signal as a function of a difference between the digital reference signal and the digital ideal reference signal.

2. The method of claim 1 wherein the analog reference signal, the digital reference signal and the ideal reference signal each comprise a same selected one of a voltage and a current.

3. The method of claim 1 wherein step [1.1] is further characterized as:
[1.1] developing a digital reference signal as a function of the analog reference signal and an analog conversion value; and
wherein step [1.2] is further characterized as:
[1.2] developing a digital ideal reference signal as a function of a selected ideal reference value and a digital conversion value equivalent to the analog conversion value.

4. The method of claim 3 wherein the analog reference signal, the digital reference signal, the ideal reference value and the conversion values each comprise a same selected one of a voltage and a current.

5. A reference signal generator facility configured to perform the method of any preceding claim.

6. An electronic system comprising a reference signal generator facility according to claim 5.

7. A non-transitory computer readable medium including executable instructions which, when executed in a processing system, causes the processing system to perform the steps of a method according to any one of claims 1 to 4.

8. A method for digitally calibrating, selectively during normal operation, a reference voltage generator adapted to develop an analog reference voltage as a function of a digital control voltage, the method comprising the steps of:
[1.1] developing a digital reference voltage as a function of the analog reference voltage;
[1.2] developing a digital ideal reference voltage, said digital ideal reference voltage being further characterized as a numerical value stored in digital format; and
[1.3] developing the digital control voltage as a function of a difference between the digital reference voltage and the digital ideal reference voltage.

9. The method of claim 8 wherein step [1.1] is further characterized as:
[1.1] developing said digital reference voltage as a function of the analog reference voltage and an analog conversion value; and
wherein step [1.2] is further characterized as:
[1.2] developing said digital ideal reference voltage as a function of a selected ideal reference value and a digital conversion value equivalent to the analog conversion value.

10. A method for digitally calibrating, selectively during normal operation, a reference current generator adapted to develop an analog reference current as a function of a digital control current, the method comprising the steps of:
[1.1] developing a digital reference current as a function of the analog reference current;
[1.2] developing a digital ideal reference current, said digital ideal reference current being further characterized as a numerical value stored in digital format; and
[1.3] developing the digital control current as a function of a difference between the digital reference current and the digital ideal reference current.

11. The method of claim 10 wherein step [1.1] is further characterized as:
[1.1] developing said digital reference current as a function of the analog reference current and an analog conversion value; and
wherein step [1.2] is further characterized as:
[1.2] developing said digital ideal reference current as a function of a selected ideal reference value and a digital conversion value equivalent to the analog conversion value.
